(19) United States
(12) Patent Application Publication
(10) Pub. No.: US 2024/0090499 A1
(43) Pub. Date: Mar. 21, 2024

(54) PRESERVATIVE COMPOSITIONS

(71) Applicant: Dermegen Inc., Hauppauge, NY (US)

(72) Inventors: Tianxiang Wang, Oviedo, FL (US); Paul Stettnisch, Lindenhurst, NY (US); Rosa Dwyer, Bay Shore, NY (US); Michael Ingrassia, Hauppauge, NY (US)

(21) Appl. No.: 18/368,780

(22) Filed: Sep. 15, 2023

Related U.S. Application Data
(60) Provisional application No. 63/407,397, filed on Sep. 16, 2022.

(51) Int. Cl. A01N 37/46

(52) U.S. Cl. CPC A01N 37/46

(57) ABSTRACT

Described herein is a preservative composition, which includes polylysine, and a medium chain fatty acid (C6-C14) or a 1-monoglyceride derivative thereof. The preservative composition is able to confer both bacterial resistance and fungal resistance without substantially including non-naturally derived products. Also described are methods of improving microbial resistance in food, beverage, cosmetic products and/or pharmaceutical products, and cosmetic compositions including the preservative composition described herein.

### CROSS-REFERENCE TO RELATED APPLICATIONS

The present application claims priority under 35 U.S.C. § 119(e) to U.S. Provisional Patent Application No. 63/407,397, filed Sep. 16, 2022, which is incorporated herein by reference in its entirety.

### BACKGROUND

The manufacturing process for cosmetics and similar products may cause biological contamination of the intermediates and final products. Furthermore, use of the cosmetic products by the consumers may lead to further repeated product contaminations. As such, preservatives should be added to cosmetics to prevent bacteria and fungi (e.g., yeasts and molds) from growing.

Currently, the vast majority of preservatives used in the cosmetic industry are synthetic in nature, such as compounds derived from petroleum products and other non-natural sources. These synthetic preservatives include phenoxyethanol, DMDM hydantoin, sodium benzoate, diazolidinyl urea, parabens, methylchloroisothiazolinone, methylisothiazolinone, and others. There are a few natural preservatives currently on the market, such as Lexgard Natural (glyceryl caprylate and glyceryl undecylenate), but they are considered weaker alternatives to the synthetic broad-spectrum preservative systems and tend to be less effective against fungi.

Therefore, there is a need for novel natural preservative systems that provide broad spectrum protection. The present invention addresses this need.

### SUMMARY

In some aspects, the present invention is directed to the following non-limiting embodiments:

### Preservative Composition

In some aspects, the present invention is directed to a preservative composition.

In some embodiments, the preservative composition comprises: polylysine; and a medium chain fatty acid (C6-C14) or a 1-monoglyceride derivative thereof.

In some embodiments, the preservative composition further comprises a glycol compound.

In some embodiments, the polylysine comprises F-poly-L-lysine.

In some embodiments, the polylysine comprises 15 lysine residues to 50 lysine residues.

In some embodiments, the amount of the polylysine in the preservative composition ranges from about 1 wt % to about 10 wt % of the preservative composition.

In some embodiments, the preservative composition comprises the 1-monoglyceride derivative of the medium chain fatty acid (C6-C14).

In some embodiments, the medium chain fatty acid (C6-C14) or the 1-monoglyceride derivative thereof is glyceryl caprylate.

In some embodiments, the amount of the medium chain fatty acid (C6-C14) or the 1-monoglyceride derivative thereof ranges from 5 wt % to 70 wt % of the preservative composition.

In some embodiments, the glycol compound comprises at least one selected from the group consisting of ethylene glycol, propanediol, butanediol, pentanediol, hexanediol, and cyclohexanediol.

In some embodiments, the glycol compound comprises propanediol;

In some embodiments, the amount of the glycol compound ranges from about 5 wt. % to about 70 wt. % of the preservative composition.

In some embodiments, the preservative composition further comprises a non-naturally derived product. In some embodiments, the preservative composition does not further comprise a non-naturally derived product. In some embodiments, the preservative composition further comprises a naturally derived product. In some embodiments, the preservative composition does not further comprise a naturally derived product. In some embodiments, apart from an agent used to adjust the pH of the preservative composition, the preservative composition does not comprise a non-naturally derived product.

### Method of Improving Microbial Resistance

In some aspects, the present invention is directed to a method of improving microbial resistance in a food, beverage, cosmetic product, and/or pharmaceutical product.

In some embodiments, the method comprising mixing the food, beverage, cosmetic product, and/or pharmaceutical product with a preservative composition. In some embodiments, the preservative composition is the same as or similar to those described elsewhere herein.

In some embodiments, the amount of the preservative composition mixed with the food, beverage, cosmetic product and/or pharmaceutical product ranges from 0.2 wt. % to 5 wt. % of the final mixture.

In some embodiments, the amount of the polylysine in the final mixture ranges from 0.01 wt. % to 0.2 wt. % of the final mixture.

In some embodiments, the amount of the medium chain fatty acid (C6-C14) or the 1-monoglyceride derivative thereof in the final mixture ranges from 0.05 wt. % to 2 wt. % of the final mixture.

In some embodiments, the amount of the medium chain fatty acid (C6-C14) or the 1-monoglyceride derivative thereof in the final mixture ranges from about 1 wt. % to about 10 wt. % of the final mixture.

### Cosmetic Composition

In some aspects, the present invention is directed to a cosmetic composition.

In some embodiments, the cosmetic composition comprises a preservative composition; and at least one selected from the group consisting of glycerin, a chelating agent, an emulsifier, a lipid, an ester, a particulate matter, a humectant, a gellant, an oil, a surfactant, caffeine, a saccharide, a hydrocarbon, a vitamin, and an antioxidant. In some embodiments, preservative composition is the same as or similar to those described elsewhere herein.

In some embodiments, the amount of the preservative composition in the cosmetic composition ranges from 0.2 wt. % to 5 wt. % of the cosmetic composition.

In some embodiments, the amount of the polylysine ranges from 0.01 wt % to 0.2 wt % of the cosmetic composition.

In some embodiments, the amount of the medium chain fatty acid (C6-C14) or the 1-monoglyceride derivative thereof ranges from 0.05 wt. % to 2 wt. % of the cosmetic composition.

In some embodiments, the amount of the medium chain fatty acid (C6-C14) or the 1-monoglyceride derivative thereof ranges from about 1 wt. % to about 10 wt. % of the cosmetic composition.

### BRIEF DESCRIPTION OF THE DRAWINGS

The following detailed description of exemplary embodiments will be better understood when read in conjunction with the appended drawings. For the purpose of illustrating, non-limiting embodiments are shown in the drawings. It should be understood, however, that the instant specification is not limited to the precise arrangements and instrumentalities of the embodiments shown in the drawings.

FIGS. 1A-1C describe certain aspects of a non-limiting natural preservative composition in accordance with some embodiments. FIG. 1A: ingredients of the non-limiting preservative, which includes the polycyclic antibacterial peptide nisin. FIG. 1B: a non-limiting cosmetic composition including the preservative composition. FIG. 1C: evaluation of the non-limiting natural preservative.

FIGS. 2A-2C describe certain aspects of a non-limiting natural preservative composition in accordance with some embodiments. FIG. 2A: ingredients of the non-limiting preservative, which includes the antifungal compound natamycin. FIG. 2B: a non-limiting cosmetic composition including the natural preservative composition. FIG. 2C: evaluation of the non-limiting natural preservative.

FIGS. 3A-3C describe certain aspects of a non-limiting natural preservative composition in accordance with some embodiments. FIG. 3A: ingredients of the non-limiting natural preservative. FIG. 3B: a non-limiting cosmetic composition including the natural preservative composition. FIG. 3C: evaluation of the non-limiting natural preservative.

FIGS. 4A-4C describe certain aspects of a non-limiting natural preservative composition in accordance with some embodiments. FIG. 4A: ingredients of the non-limiting natural preservative. FIG. 4B: a non-limiting cosmetic composition including the natural preservative composition. FIG. 4C: evaluation of the non-limiting natural preservative.

FIGS. 5A-5C describe certain aspects of a non-limiting natural preservative composition in accordance with some embodiments. FIG. 4A: ingredients of the non-limiting natural preservative. FIG. 5B: a non-limiting cosmetic composition including the natural preservative composition. FIG. 5C: evaluation of the non-limiting natural preservative.

FIGS. 6A-6B describe certain aspects of a non-limiting natural preservative composition in accordance with some embodiments. FIG. 6A: a non-limiting cosmetic composition including a natural preservative composition that includes Glyceryl Caprylate (GMCY) but not polylysine. FIG. 6B: evaluation of the GMCY based preservative.

FIGS. 7A-7B describe certain aspects of a non-limiting natural preservative composition in accordance with some embodiments. FIG. 7A: a non-limiting cosmetic composition including a natural preservative composition that includes polylysine but not Glyceryl Caprylate (GMCY). FIG. 7B: evaluation of the polylysine based preservative.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Polylysine is a natural, cationic preservative used in foods. Polylysine, on its own, is considered a weak preservative against fungal microorganisms such as molds. Medium chain fatty acids (C6-C14) and 1-monoglyceride derivatives thereof, such as but not limited to glyceryl caprylate, are natural preservatives and are considered weak preservatives against molds, as well.

The study described herein (“the present study”) made the surprising discovery that polylysine, when combined with medium chain fatty acids (C6-C14) or 1-monoglyceride derivatives thereof, become extremely effective at killing molds. As such, natural preservative compositions including both polylysine and medium chain fatty acids (C6-C14) or 1-monoglyceride derivatives thereof can be used as broad-spectrum preservative systems, such as broad-spectrum preservative systems for cosmetic compositions.

Accordingly, in some embodiments, the present invention is directed to a preservative composition.

In some embodiments, the present invention is directed to a method of improving microbial resistance of a food, beverage, cosmetic product, and/or pharmaceutical product.

In some embodiments, the present invention is directed to a microbial-resistant cosmetic composition.

It is worth nothing that, although a significant portion of the instant specification describes using the preservative composition in conjunction with cosmetic compositions, since polylysine and medium chain fatty acids (C6-C14) or 1-monoglyceride derivatives thereof are considered safe for human consumption, it is expected that the instant preservative composition is useful for any products in which uncontrolled microbial growths are undesirable. Such products include food products, beverages, pharmaceutical compositions, paints, biological samples, and many others.

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein and the laboratory procedures in animal pharmacology, pharmaceutical science, peptide chemistry, and organic chemistry are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.”

“About” as used herein when referring to a measurable value such as an amount, a temporal duration, and the like, is meant to encompass variations of 20% or ±10%, in certain embodiments+5%, in certain embodiments+1%, in certain embodiments+0.1% from the specified value, as such variations are appropriate to perform the disclosed methods.

### Preservative Compositions

Medium chain fatty acids (C6-C14) and 1-monoglyceride derivatives thereof are known to have only weak anti-fungal activities (Ahn et al., Journal of the Society of Cosmetic Scientists of Korea, Volume 33 Issue 1 Serial No. 60, Pages 47-52, 2007). Similarly, polylysine is known to be only weakly anti-fungal.

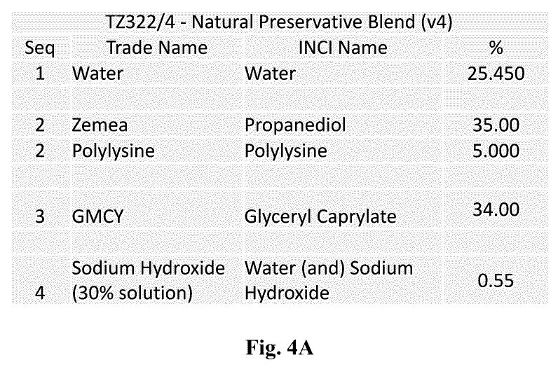

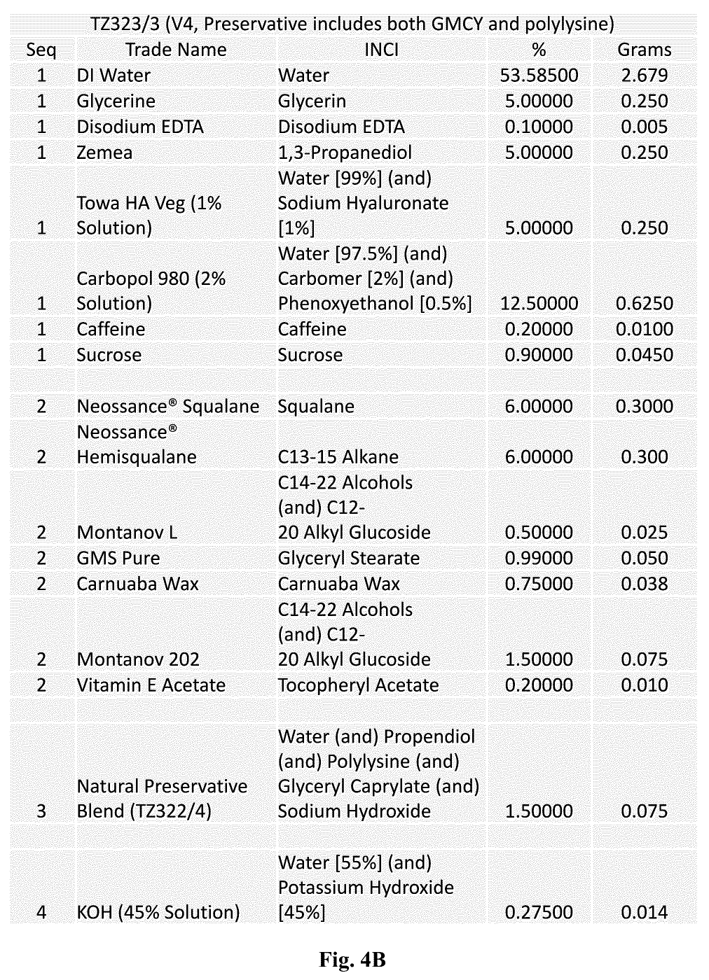

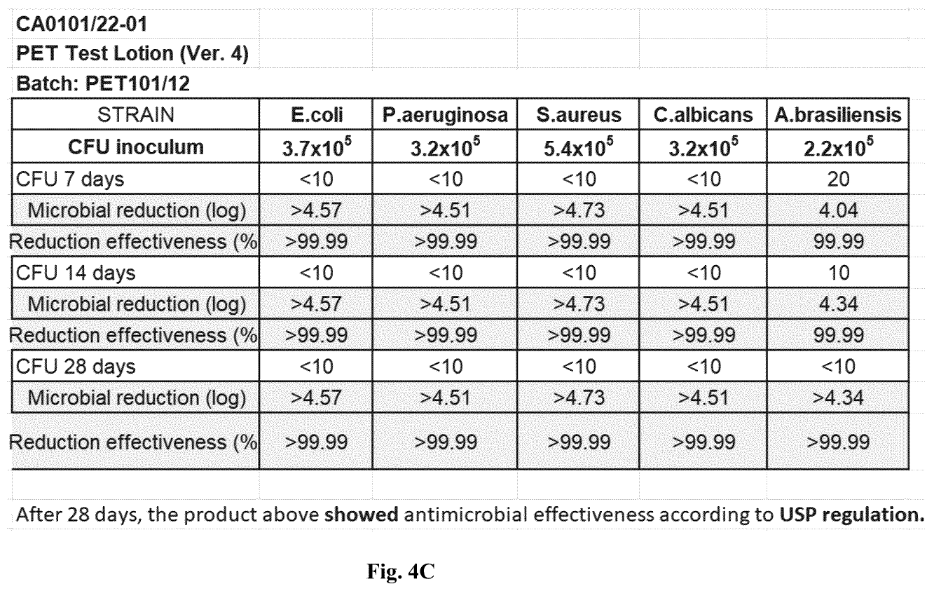

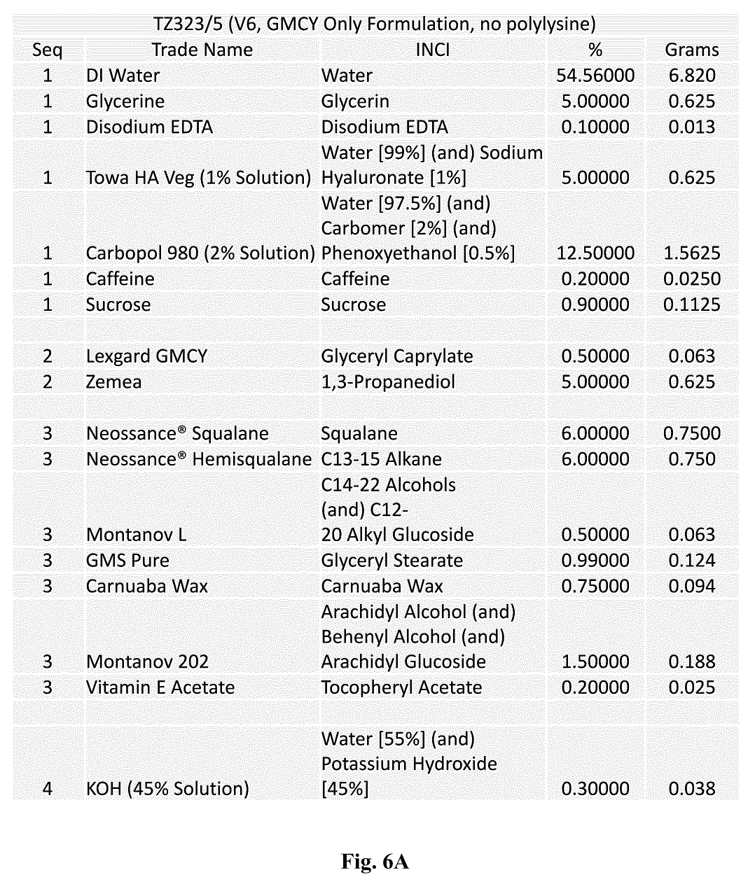

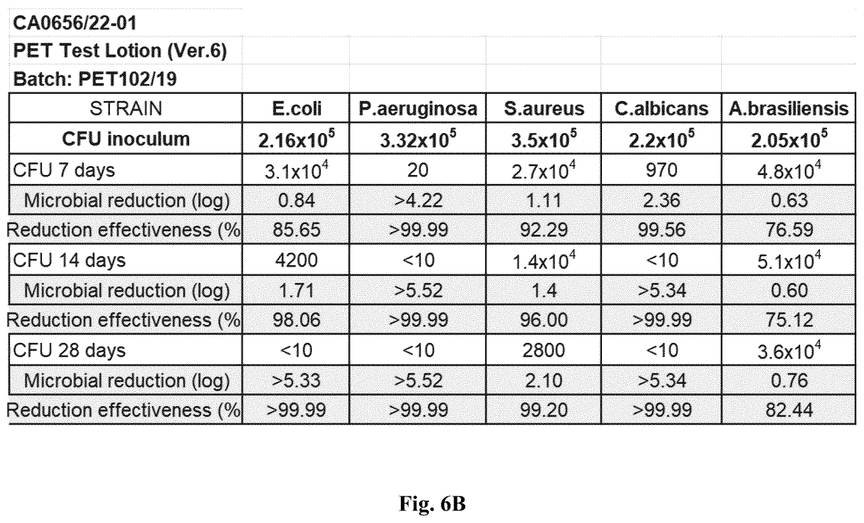

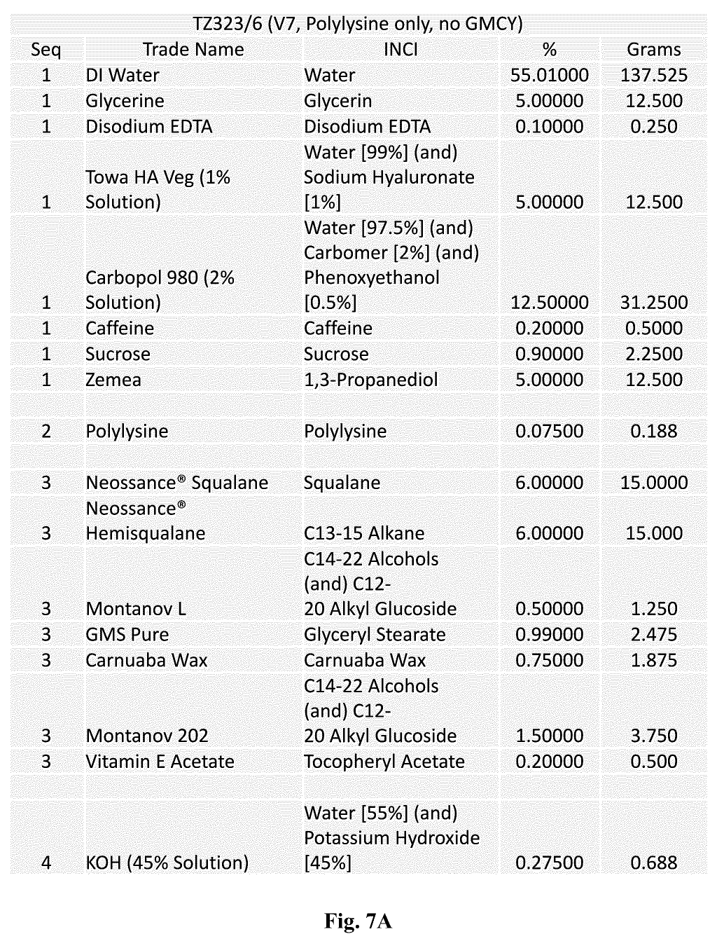

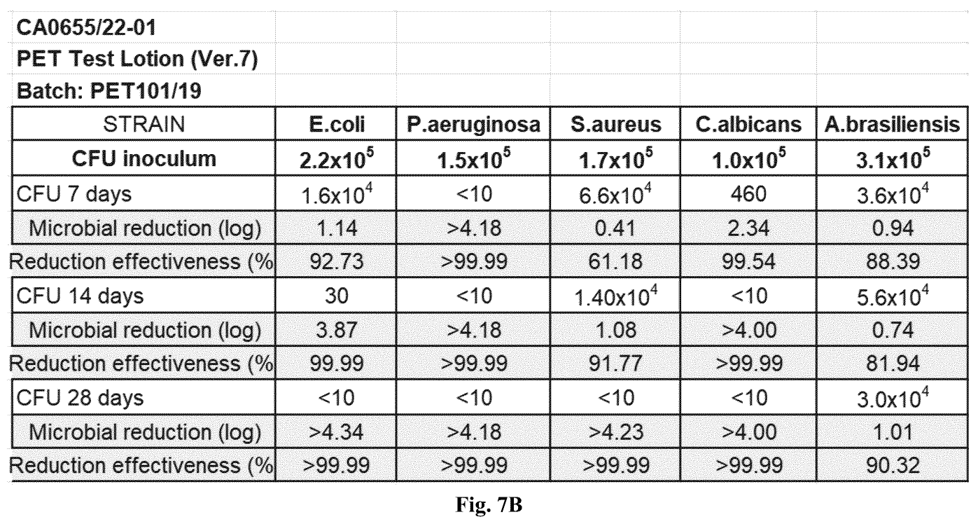

Unexpectedly, the study described herein (“the present study”) discovered that the combinations of polylysine and medium chain fatty acids/1-monoglyceride derivatives of medium chain fatty acids are able to strongly inhibit microorganism growth, including fungal growth. For example, the present study shows that a composition including both polylysine and glyceryl caprylate (see e.g., Example 1-4 and FIGS. 4A-4C) are much more effective at inhibiting fungal growth than similar compositions that include only glyceryl caprylate (see e.g., Example 1-6 and FIGS. 6A-6B) or only polylysine (see e.g., Example 1-7 and FIGS. 7A-7B).

Accordingly, in some aspects, the present invention is directed to a preservative composition.

In some embodiments, the preservative composition includes polylysine and a medium chain fatty acid (C6-C14) or a 1-monoglyceride derivative thereof. In some embodiments, the preservative composition is effective against both bacteria and fungi growth. In some embodiments, when subjecting to the antimicrobial effectiveness testing as set forth in U.S. Pharmacopeia, Chapter <51>, the preservative composition has a reduction effectiveness for each of the tested microbial strains for 95% or more, such as 98% or more, 99% or more, 99.5% or more, 99.9% or more, 99.95% or more or 99.99% or more after 7 days, 14, days, or 28 days. The entirety of the U.S. Pharmacopeia is hereby incorporated herein by reference.

In some embodiments, the polylysine is a poly-L-lysine, a poly-D-lysine, or combinations thereof. In some embodiments, the polylysine is an α-polylysine in which polymer linkages are formed between α-carboxyl and F-amino group of adjacent residues. In some embodiments, the polylysine is an F-polylysine in which polymer linkages are formed between α-carboxyl and F-amino group of adjacent residues. In some embodiments, the polylysine is an F-poly-L-lysine, an α-poly-L-lysine, an F-poly-D-lysine, an α-poly-D-lysine, or combinations thereof.

In some embodiments, the polylysine includes about 2 lysine residues to about 100 lysine residues, such as about 5 lysine residues to about 100 lysine residues, about 8 lysine residues to about 75 lysine residues, about 10 lysine residues to about 60 lysine residues, about 15 lysine residues to about 50 lysine residues, about 20 lysine residues to about 40 lysine residues, or about 25 lysine residues to about 30 lysine residues.

In some embodiments, the polylysine is a synthetic polylysine. In some embodiments, the polylysine is produced from biomanufacturing, such as by fermentation. The bio-manufactured polylysine is commercially available and the manufacturing processes are described in, for example, Hirohara et al. (Appl. Microbiol. Biotechnol. 76 (5), 1009-1016, 2007) and Wang et al. (Microbiologyopen 8, e00728, 2019).

In some embodiments, the amount of the polylysine in the preservative composition ranges from about 1 wt % to about 10 wt % based on 100 wt % of the preservative composition, such as from about 2 wt % to about 7.5 wt %, from about 2.5 wt % to about 6 wt %, or from about 3 wt % to about 5 wt %, based on 100 wt % of the preservative composition.

In some embodiments, the preservative composition includes a medium chain fatty acid (C6-C14). Examples of medium fatty acids include a saturated medium fatty, such as caproic acid (C6), enanthic acid (C7), caprylic acid (C8), pelargonic acid (C9), capric acid (C10), undecylic acid(C11), lauric acid (C12), tridecylic acid (C13), myristic acid (C14), and the like.

In some embodiments, the preservative composition includes a 1-monoglyceride derivative of a medium chain fatty acid (C6-C14), such as a 1-monoglyceride derivative of the medium chain fatty acid above. In some embodiments, the 1-monoglyceride derivative of the medium chain fatty acid includes glyceryl monocaprylate.

In some embodiments, the medium chain fatty acid (C6-C14) or the 1-monoglyceride derivative thereof is glyceryl caprylate.

In some embodiments, the amount of the medium chain fatty acid (C6-C14) or the 1-monoglyceride derivative thereof ranges from about 5 wt. % to about 70 wt. % based on 100 wt. % of the preservative composition, such as from about 10 wt. % to about 60 wt. %, from about 15 wt. % to about 50 wt. %, or from about 20 wt. % to about 40 wt. % based on 100 wt. % of the preservative composition.

In some embodiments, the preservative composition further includes a glycol compound. Glycol compounds typically do not have antimicrobial activities (with some exceptions such as hexanediol which can act as a preservative adjuvant and/or supplement). However, a sufficiently high concentration of glycol compound is able to reduce the water activity and thereby prevent microbial growth. Furthermore, the inclusion of a glycol compound in the preservative composition improves the solubility of the components in the preservative composition.

As used herein, the term “glycol compound” refers to aliphatic diols and derivatives thereof. Non-limiting examples of glycol compounds include ethylene glycol, propanediol (such as 1,3-propanediol or 1,2-propanediol), butanediol (such as 1,2-butanediol, 1,4-butanediol, 1,3-butanediol, or 2,3-butanediol), pentanediol (such as 1,5-pentanediol or 1,2-pentanediol), hexanediol, cyclohexanediol, and the like, as well as derivatives thereof.

In some embodiments, an amount of the glycol compound ranges from about 5 wt. % to about 70 wt. % based on 100 wt. % of the preservative composition, such as from about 10 wt. % to about 60 wt. %, from about 15 wt. % to about 50 wt. %, or from about 20 wt. % to about 40 wt. % based on 100 wt. % of the preservative composition.

In some embodiments, the preservation composition further includes water. In some embodiments, the preservative composition is an aqueous composition. In some embodiments, the amount of the water in the preservative composition ranges from about 5 wt. % to about 70 wt. %, such as from about 10 wt. % to about 60 wt. %, from about 15 wt. % to about 50 wt. %, or from about 20 wt. % to about 40 wt. %.

In some embodiments, the preservative composition further comprises a non-naturally derived product. In some embodiments, the preservative composition does not further comprise a non-naturally derived product. In some embodiments, the preservative composition further comprises a naturally derived product. In some embodiments, the preservative composition does not further comprise a naturally derived product. In some embodiments, apart from agents used to adjust the pH of the preservative composition, the composition does not substantially include a non-naturally derived product. As used herein, the term “naturally derived product” refers to any substance where the starting material is of mineral, plant, microbe, or animal origin but has been chemically processed; any substance where the starting material is of mineral, plant, microbe, or animal origin but has been chemically processed and combined with other ingredients, excluding petroleum and fossil fuel-derived ingredients; or an ingredient that is derived from a plant feedstock and bio-manufactured using processes like fermentation, saponification, condensation, or esterification in order to improve performance or make the ingredient biodegradable or sustainable.

In some embodiments, apart from agents used to adjust the pH of the preservative composition, the composition further includes one or more non-naturally derived product. In some embodiments, the one or more non-naturally derived product includes one or more non-naturally derived preservatives. Examples of suitable non-naturally derived preservatives includes phenoxyethanol, 1,3-Bis(hydroxymethyl)-5,5-dimethylimidazolidine-2,4-dione (DMDM hydantoin), sodium benzoate, diazolidinyl urea, parabens, methylchloroisothiazolinone, methylisothiazolinone, and the like.

In some embodiments, the preservative composition does not include a non-naturally derived preservative.

In some embodiments, the preservative composition further includes an anti-fungal compound, such as compound that alone has anti-fungal activities. Example of anti-fungal compounds include chlorphenesin, dehydroacetic acid, glyceryl undecylenate, miconazole nitrate, natamycin, potassium sorbate, tolfonate, and the like.

Methods of Improving Microbial Resistance in Food, Beverage, Cosmetic Product, and/or Pharmaceutical Product

In some embodiments, the instant specification is directed to a method of improving microbial resistance in a food, beverage, cosmetic product, and/or pharmaceutical product.

In some embodiments, the method includes mixing the food, beverage, cosmetic product, and/or pharmaceutical product with a preservative composition. In some embodiments, the preservative composition is the same as or similar to those as described elsewhere herein, such as in the “Preservative Composition” section.

In some embodiments, the amount of the preservative composition mixed with the food, beverage, cosmetic product, and/or pharmaceutical product ranges from about 0.2 wt. % to about 5 wt. % based on 100 wt. % of the final mixture (i.e., the mixture of the food, beverage, cosmetic product, and/or pharmaceutical product and the preservative composition), such as from about 0.5 wt. % to about 3 wt. %, or from about 0.75 wt. % to about 2 wt. % based on 100 wt. % of the final mixture.

In some embodiments, the amount of the polylysine in the final mixture ranges from about 0.01 wt. % to about 0.2 wt. % based on 100 wt. % of the final mixture, such as about 0.02 wt. % to about 0.15 wt. %, about 0.03 wt. % to about 0.1 wt. %, or about 0.04 wt. % to about 0.08 wt. % based on 100 wt. % of the final mixture.

In some embodiments, the amount of the glyceryl caprylate or glyceryl undecylenate in the final mixture ranges from about 0.05 wt. % to about 2 wt. % based on 100 wt. % of the final mixture, such as from about 0.075 wt. % to about 1.5 wt. %, from about 0.1 wt. % to about 1 wt. %, from about 0.15 wt. % to about 0.75 wt. %, or from about 0.3 wt. % to about 0.6 wt. % based on 100 wt. % of the final mixture.

In some embodiments, the food, beverage, cosmetic product, and/or pharmaceutical product includes a glycol compound in addition to the glycol compound in the preservative composition. In some embodiments, the method further includes adding a glycol compound to the final mixture. In some embodiments, the glycol compound in the food, beverage, cosmetic product, and/or pharmaceutical product or the glycol compound added to the final mixture is the same as or similar to those as described elsewhere, such as in the “Preservative Composition” section herein. In some embodiments, the total amount of the glycol compound (including the glycol compound in the preservative composition, the glycol compound in the food, beverage, cosmetic product, and/or pharmaceutical product and the glycol compound added separately) ranges from about 1 wt. % to about 10 wt. % based on 100 wt. % of the final mixture, such as from about 2 wt. % to about 7.5 wt. %, or from about 3 wt. % to about 6 wt. % based on 100 wt. % of the final mixture.

In some embodiments, the method renders the final mixture resistant against bacteria and/or fungi growth. In some embodiments, when subjecting to the antimicrobial effectiveness testing as set forth in U.S. Pharmacopeia, Chapter <51>, the final mixture has a reduction effectiveness for each of the tested microbial strains for 95% or more, such as 98% or more, 99% or more, 99.5% or more, 99.9% or more, 99.95% or more or 99.99% or more after 7 days, 14, days, or 28 days. The entirety of the U.S. Pharmacopeia is hereby incorporated herein by reference.

### Cosmetic Compositions

In some aspects, the present invention is directed to a cosmetic composition. In some embodiments, the cosmetic composition is a microbial-resistant cosmetic composition. In some embodiment, the cosmetic composition includes a preservative composition. In some embodiments, the preservative composition is the same as or similar to those described elsewhere herein, such as in the “Preservative Composition” section.

In some embodiments, the amount of the preservative composition in the cosmetic composition ranges from about 0.2 wt. % to about 5 wt. % based on 100 wt. % of the cosmetic composition, such as from about 0.5 wt. % to about 3 wt. %, or from about 0.75 wt. % to about 2 wt. % based on 100 wt. % of the cosmetic composition.

In some embodiments, the cosmetic composition is prepared by mixing all of the components thereof at the same time. In some embodiments, the components of the preservative composition are mixed in different orders and/or steps.

In some embodiments, the amount of the polylysine in the cosmetic composition ranges from about 0.01 wt. % to about 0.2 wt. % based on 100 wt. % of the cosmetic composition, such as about 0.02 wt. % to about 0.15 wt. %, about 0.03 wt. % to about 0.1 wt. %, or about 0.04 wt. % to about 0.08 wt. % based on 100 wt. % of the cosmetic composition.

In some embodiments, the cosmetic composition includes a glycol compound in addition to the glycol compound in the preservative composition. In some embodiments, the additional glycol compound in the cosmetic composition is the same as or similar to those as described elsewhere, such as in the “Preservative Composition” section herein. In some embodiments, the total amount of the glycol compound ranges from about 1 wt % to about 10 wt % based on 100 wt % of the cosmetic composition, such as from about 2 wt % to about 7.5 wt %, or from about 3 wt % to about 6 wt % based on 100 wt % of the cosmetic composition.

In some embodiments, the amount of the medium chain fatty acid (C6-C14) or the 1-monoglyceride derivative thereof (such as glyceryl caprylate) in the cosmetic composition ranges from about 0.05 wt % to about 2 wt % based on 100 wt % of the cosmetic composition, such as from about 0.075 wt % to about 1.5 wt %, from about 0.1 wt % to about 1 wt %, from about 0.15 wt % to about 0.75 wt %, or from about 0.3 wt % to about 0.6 wt % based on 100 wt % of the cosmetic composition.

In some embodiments, the preservative composition further comprises a non-naturally derived product. In some embodiments, the preservative composition does not further comprise a non-naturally derived product. In some embodiments, the preservative composition further comprises a naturally derived product. In some embodiments, the preservative composition does not further comprise a naturally derived product. In some embodiments, apart from agents used to adjust pH of the cosmetic composition, the preservative composition, or other components of the cosmetic composition, the cosmetic composition does not substantially include a non-naturally derived product. The definition of “naturally derived product” is set forth elsewhere herein.

In some embodiments, the cosmetic composition is resistant against bacteria and/or fungi growth. In some embodiments, when subjecting to the antimicrobial effectiveness testing as set forth in U.S. Pharmacopeia, Chapter <51>, the cosmetic resistant has a reduction effectiveness for each of the tested microbial strains for 95% or more, such as 98% or more, 99% or more, 99.5% or more, 99.9% or more, 99.95% or more or 99.99% or more after 7 days, 14, days, or 28 days. The entirety of the U.S. Pharmacopeia is hereby incorporated herein by reference.

In some embodiments, the cosmetic composition further includes water, glycerin, a chelating agent (such as ethylenediaminetetraacetic acid (EDTA)), an emulsifier, a lipid, an ester, a particulate matter, a humectant, a gellant, an oil, a surfactant, caffeine, a saccharide (such as sucrose), a hydrocarbon (such as squalane), a vitamin, an antioxidant, or combinations thereof.

### EXAMPLES

The instant specification further describes in detail by reference to the following experimental examples. These examples are provided for purposes of illustration only, and are not intended to be limiting unless so specified. Thus, the instant specification should in no way be construed as being limited to the following examples, but rather, should be construed to encompass any and all variations which become evident as a result of the teaching provided herein.

### Example 1: Overview

The manufacturing process for cosmetics and similar products may cause biological contamination of the intermediates and final products. Furthermore, use of the cosmetic products by the consumers may lead to further repeated product contaminations. As such, preservatives should be added to cosmetics to stop bacteria and fungi (e.g., yeasts and molds) from growing.

Several natural preservative compositions in accordance with some embodiments were prepared and cosmetic compositions were made using these preservative compositions. The cosmetic compositions were then sent to an independent research and analytical service company, Abich in Canada, to be tested in a Challenge Test in accordance with U.S. Pharmacopoeia, Chapter <51>.

The Challenge Test is a predictive method useful to evaluate the effectiveness of a preserving system used in the formulation of a non-sterile cosmetic, drugs, detergent products or similar ones. By means of laboratory artificial contamination the tester reproduces the environmental microbial pollution of the investigated products, that undergo during manufacturing, storing and consumer use. In this way information on the product's resistance to microbial attacks and on its stability can be obtained.

This Challenge Test was preceded by an examination of the total microbial load of the product. The samples were then inoculated with an excessively high concentration of micro-organism that is hardly found in the environment that cosmetics are normally subjected to. The samples are contaminated with various microbial strains, as described below, and their reduction in growth is evaluated at different end times.

The non-limiting cosmetic compositions tested as well as the results are described below.

### Example 1-1: Sample 1

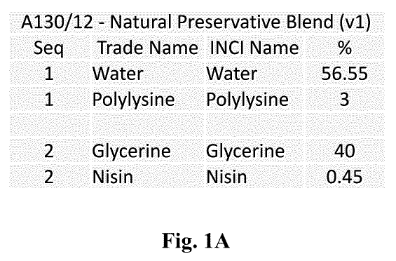

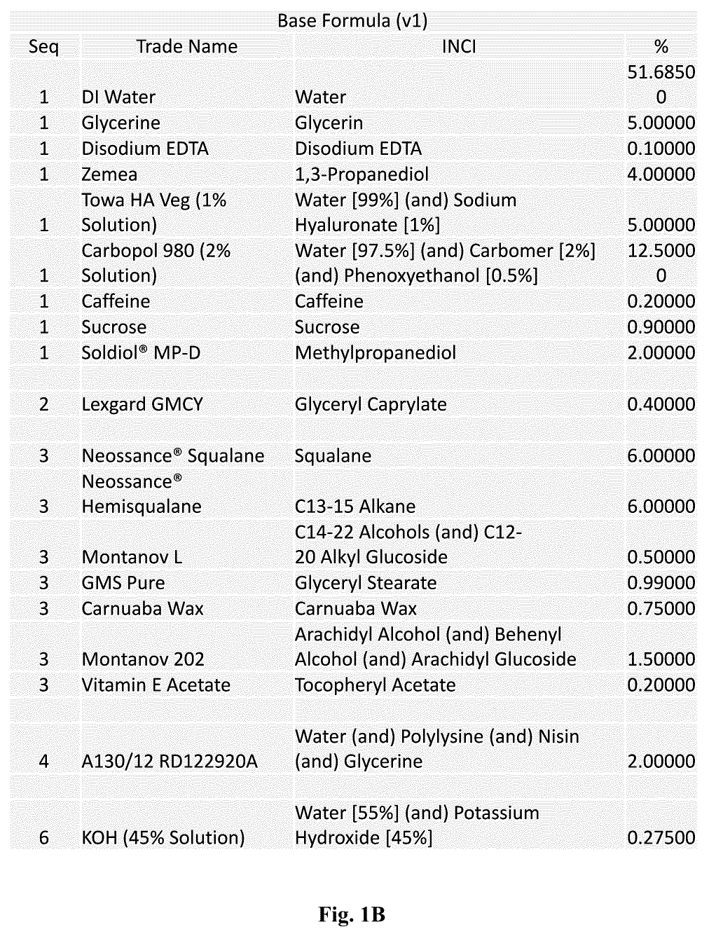

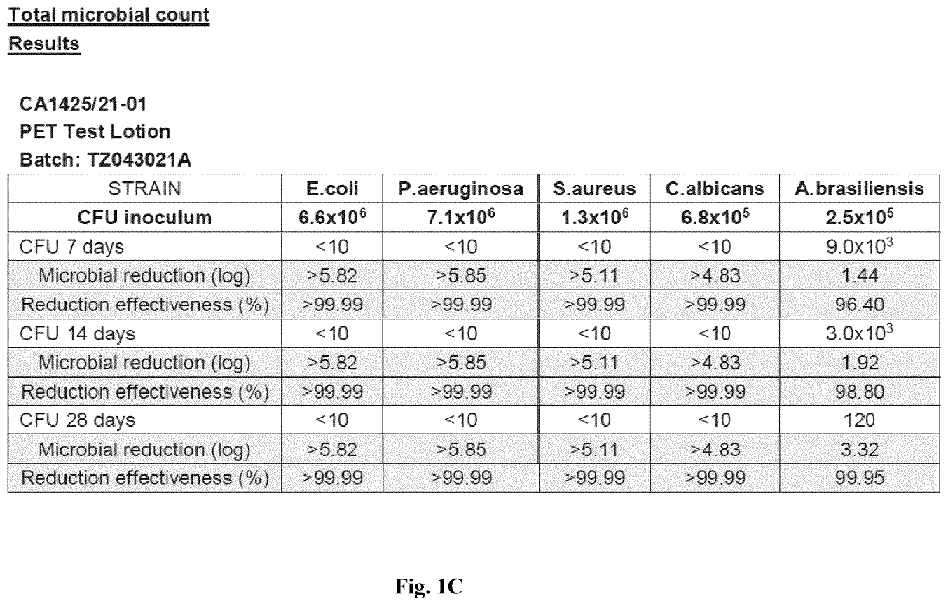

Referring to FIG. 1A, a non-limiting preservative composition including polylysine and nisin were prepared. Referring to FIG. 1B, a base composition for a cosmetic composition was prepared using the non-limiting preservative composition of FIG. 1A.

Three bacteria strains, Escherichia co/i ATCC 8739, Pseudomonas aeruginosa ATCC 9027 and Staphylococcus aureus ATCC 6538 were inoculated on casein soya bean digest agar growth medium. Two fungi strains, Candida albicans ATCC 10231 and Aspergillus brasiliensis ATCC 16404, were inoculated on sabouraud-dextrose agar growth medium. The three bacteria strains were incubated at 32.5±2.5° C. for 18-24 h. The Candida strain was inoculated at 22.5±2.5° C. for 44-52 h and the Aspergillus strain was at 22.5±2.5° C. for 6-10 days. The microbial strains were suspended in a physiologic solution and inoculated in the tested product. The treated samples were then stored at room temperature protected from light until plating for the microbial count. The concentration of viable cells at every end-time is determined by the plate count method, diluting the product in a solution of sodium chloride-peptone added with neutralizers for the most common preservatives (polysorbate 80, soya lecithin, thiosulfate, L-Histidine).

The microbial count at different endpoints is carried out diluting 1 g/ml of product up to 1×10⁶ times and plating each dilution in a petri dish with selective agar medium.

The plates were kept at 32.5±2.5° C. (bacteria) or at 22.5±2.5° C. (yeast and mold) for the time necessary for a good growth (3-5 days for bacteria and yeast, 3-7 days for molds). The CFU (colony-forming unit) value for gram or milliliter of product is obtained from the number of colonies on the plate for the dilution factor.

To evaluate the microbial reduction in time, plate counts are carried out at three end-times normally after 7, 14 and 28 days from the starting inoculum.

The initial inoculation concentration as well as the microbial counts, the microbial reduction, and the reduction effectiveness after 7, 14 and 28 days are listed in FIG. 1C.

Referring to FIGS. 1A-1C, the nisin-based preservative conferred the base composition with good antimicrobial properties, although the anti-fungal properties (see data regarding A. brasiliensis) are not ideal.

### Example 1-2: Sample 2

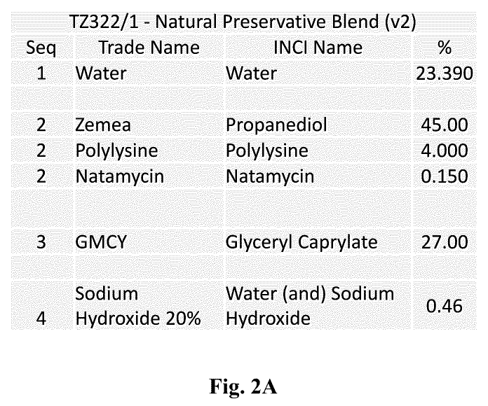

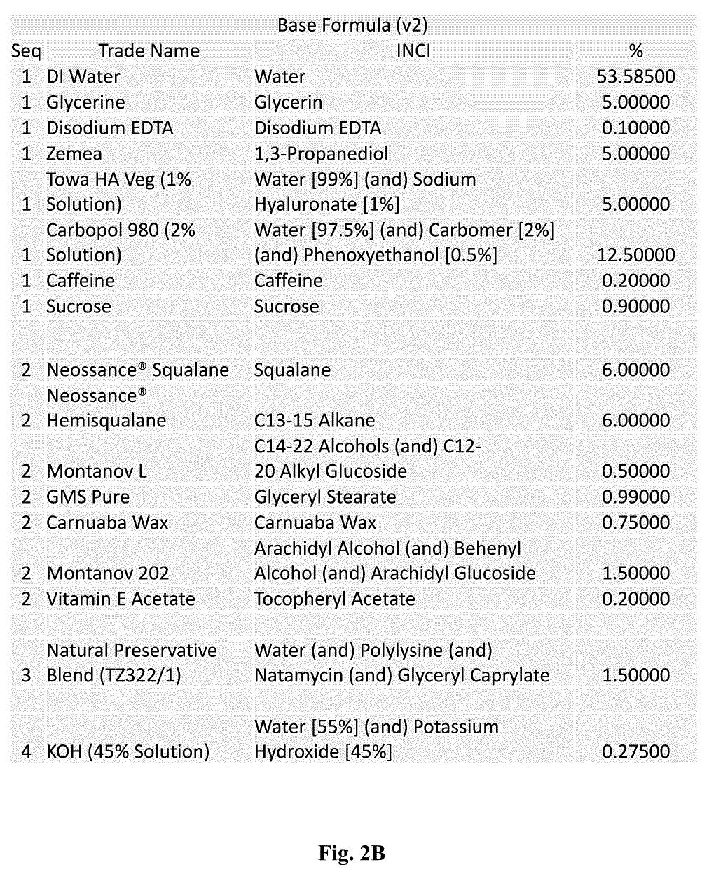

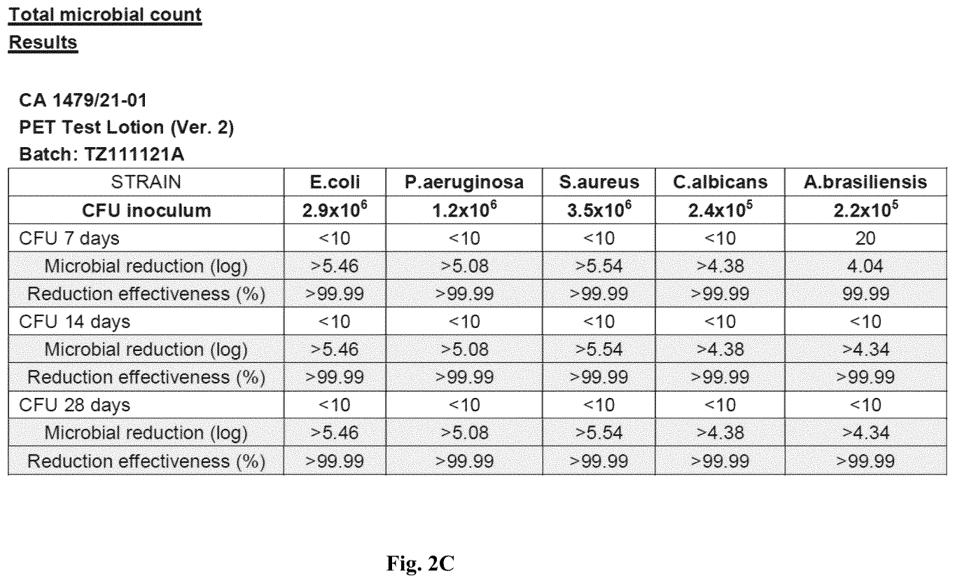

Referring to FIG. 2A, a non-limiting preservative composition including polylysine, natamycin and glyceryl caprylate was prepared. Referring to FIG. 2B, a base composition for a cosmetic composition was prepared using the non-limiting preservative composition of FIG. 2A.

The composition of FIG. 2B was analyzed in the same manner as Example 1-1. The results are shown in FIG. 2C.

As shown in FIGS. 2A-2C, the preservative composition conferred the base composition with desirable antimicrobial properties, including anti-fungal properties. However, the preservative composition includes the anti-fungal medication natamycin, which is an antibiotic. Without wishing to be limited by any theory, regulatory agencies in many countries may not allow the inclusion of antibiotics in cosmetics, food products or beverages. In certain non-limiting embodiments, the use of natamycin in non-pharmaceutical products is not feasible.

### Example 1-3: Sample 3

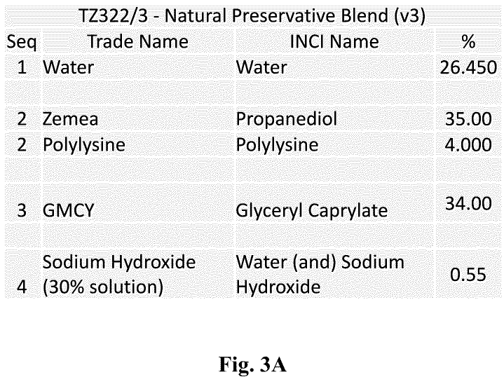

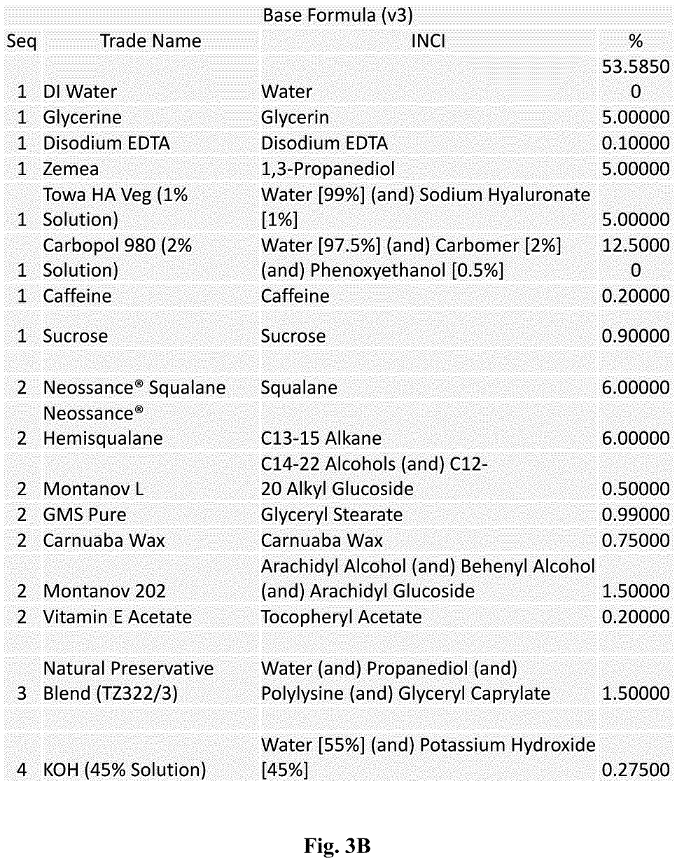

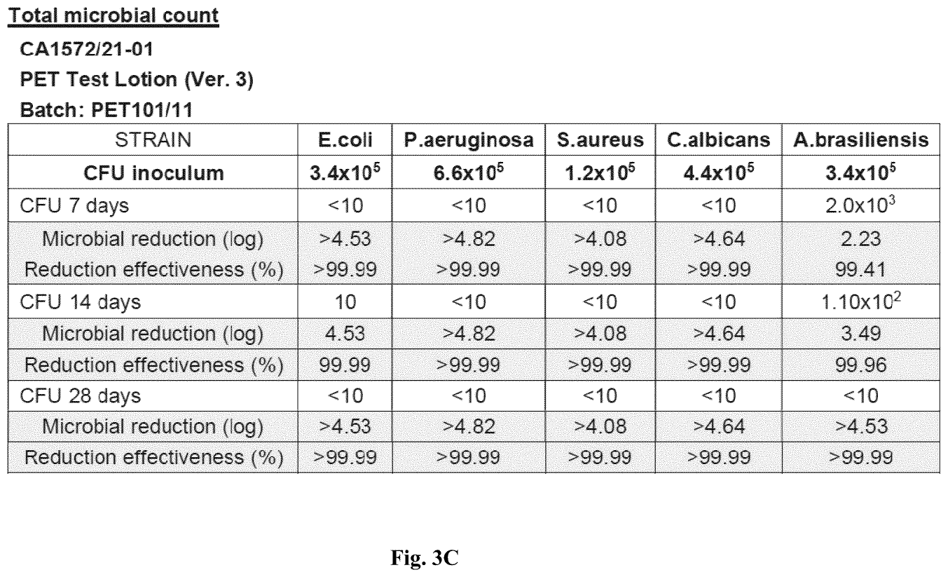

Referring to FIG. 3A, a non-limiting natural preservative composition including polylysine and glyceryl caprylate was prepared. Referring to FIG. 3B, a base composition for a cosmetic composition was prepared using the non-limiting natural preservative composition of FIG. 3A.

The composition of FIG. 3B was analyzed in the same manner as Example 1-1. The results are shown in FIG. 3C.

As shown in FIGS. 3A-3C, the inclusion of the non-limiting natural preservative in the base composition conferred the base composition with excellent antimicrobial properties, including excellent anti-fungal properties (see data regarding A. brasiliensis).

### Example 1-4: Sample 4

Referring to FIG. 4A, a non-limiting natural preservative composition including polylysine and glyceryl caprylate was prepared. Referring to FIG. 4B, a base composition for a cosmetic composition was prepared using the non-limiting natural preservative composition of FIG. 4A.

The composition of FIG. 4B was analyzed in the same manner as Example 1-1. The results are shown in FIG. 4C.

As shown in FIGS. 4A-4C, the inclusion of 1.5% of the non-limiting natural preservative in the base composition conferred the base composition with excellent antimicrobial properties, including excellent anti-fungal properties (see data regarding A. brasiliensis).

### Example 1-5: Sample 5

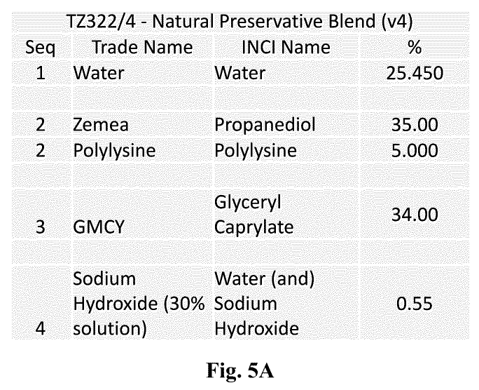

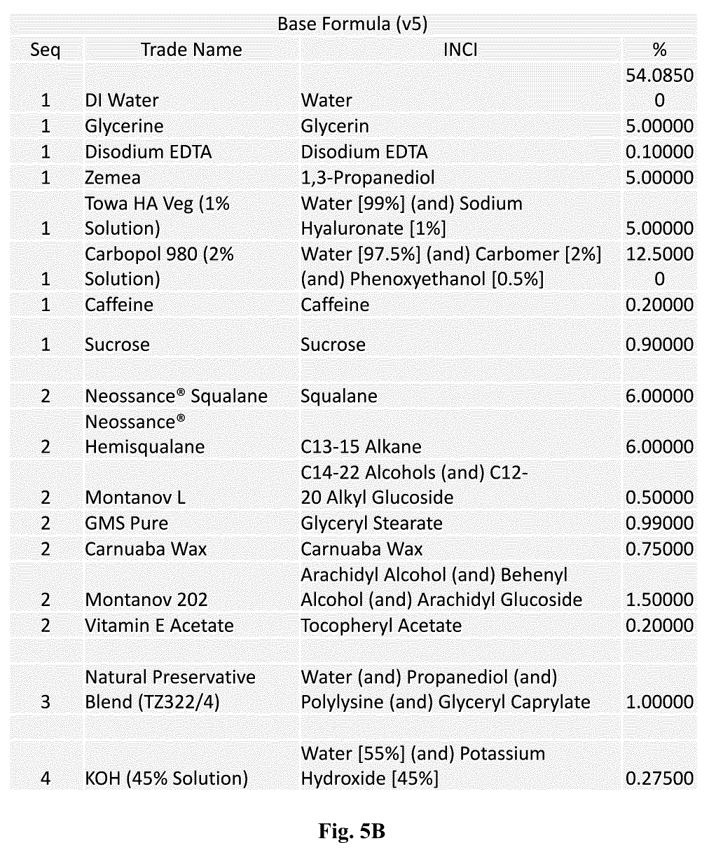

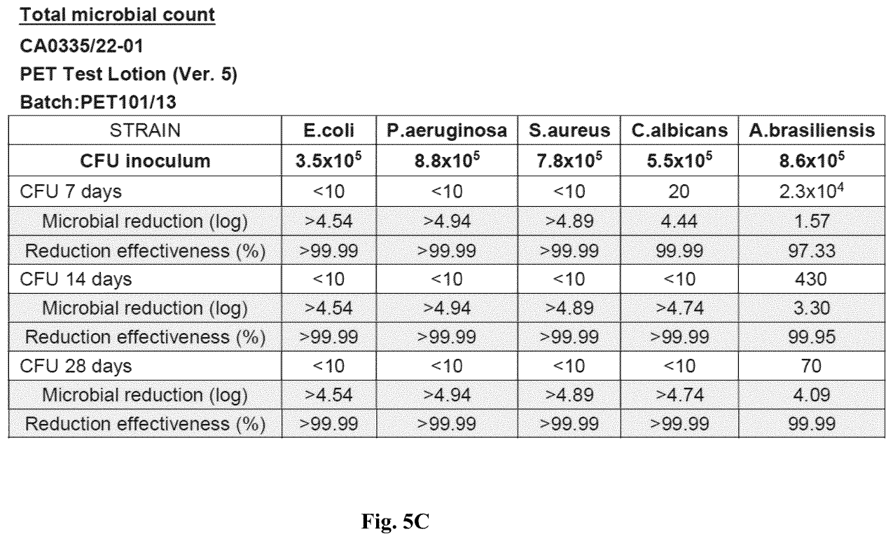

Referring to FIG. 5A, a non-limiting natural preservative composition including water, propanediol, polylysine, glyceryl caprylate and sodium hydroxide were prepared. Referring to FIG. 5B, a base composition for a cosmetic composition was prepared using the non-limiting natural preservative composition of FIG. 5A.

The composition of FIG. 5B was analyzed in the same manner as Example 1-1. The results are shown in FIG. 5C.

As shown in FIGS. 5A-5C, the inclusion of the non-limiting natural preservative in the base composition conferred the base composition with excellent antimicrobial properties, including good anti-fungal properties (although less excellent than those shown in Example 1-4 due to that only 1%, rather than 1.5%, of the same natural preservative was included).

### Example 1-6: Sample 6

Referring to FIG. 6A, a non-limiting base composition of a cosmetic composition (version 6) was prepared using a preservative including glyceryl caprylate (“Lexgard GMCY”).

The base composition of FIG. 6A was analyzed in the same manner as Example 1-1. The results are shown in FIG. 6B.

Referring to FIG. 6B, although the formulation of non-limiting base composition version 6 is similar to the version 4 base composition of Example 1-4, the version 6 base composition has less resistance to microorganism growth, especially fungal (A. brasiliensis) growth (see e.g., FIG. 4C).

### Example 1-7: Sample 7

Referring to FIG. 7A, a non-limiting base composition of a cosmetic composition (version 7) was prepared using a preservative including polylysine.

The base composition of FIG. 7A was analyzed in the same manner as Example 1-1. The results are shown in FIG. 7B.

Referring to FIG. 7B, although the formulation of the non-limiting base composition version 7 is similar to the version 4 base composition of Example 1-4, the version 7 base composition has less resistance to microorganism growth, especially fungal (A. brasiliensis) growth (see e.g., FIG. 4C).

### Enumerated Embodiments

In some aspects, the present study is directed to the following non-limiting embodiments.

Embodiment 1: A preservative composition, comprising: polylysine; and a medium chain fatty acid (C6-C14) or a 1-monoglyceride derivative thereof.

Embodiment 2: The preservative composition of Embodiment 1, further comprising: a glycol compound.

Embodiment 3: The preservative composition of Embodiment 1, wherein at least one of the following applies:
the polylysine comprises F-poly-L-lysine;
the polylysine comprises 15 lysine residues to 50 lysine residues;
the amount of the polylysine in the preservative composition ranges from about 1 wt % to
about 10 wt % of the preservative composition.

Embodiment 4: The preservative composition of Embodiment 1, wherein at least one of the following applies:
the preservative composition comprises the 1-monoglyceride derivative of the medium
chain fatty acid (C6-C14);
the medium chain fatty acid (C6-C14) or the 1-monoglyceride derivative thereof is
glyceryl caprylate;
the amount of the medium chain fatty acid (C6-C14) or the 1-monoglyceride derivative
thereof ranges from 5 wt % to 70 wt % of the preservative composition.

Embodiment 5: The preservative composition of Embodiment 2, wherein at least one of the following applies:
the glycol compound comprises at least one selected from the group consisting of
ethylene glycol, propanediol, butanediol, pentanediol, hexanediol, and cyclohexanediol;
the glycol compound comprises propanediol;
the amount of the glycol compound ranges from about 5 wt % to about 70 wt % of the preservative composition.

Embodiment 6: The preservative composition Embodiment 1, wherein apart from an agent used to adjust the pH of the preservative composition, the preservative composition does not comprise a non-naturally derived product.

Embodiment 7: The preservative composition Embodiment 2, wherein apart from an agent used to adjust the pH of the preservative composition, the preservative composition does not comprise a non-naturally derived product.

Embodiment 8: A method of improving microbial resistance in a food, beverage, cosmetic product, and/or pharmaceutical product, the method comprising mixing the food, beverage, cosmetic product, and/or pharmaceutical product with a preservative composition of Embodiment 1.

Embodiment 9: The method of Embodiment 8, wherein the amount of the preservative composition mixed with the food, beverage, cosmetic product and/or pharmaceutical product ranges from 0.2 wt % to 5 wt % of the final mixture.

Embodiment 10: The method of Embodiment 8, wherein the amount of the polylysine in the final mixture ranges from 0.01 wt % to 0.2 wt % of the final mixture.

Embodiment 11: The method of Embodiment 8, wherein the amount of the medium chain fatty acid (C6-C14) or the 1-monoglyceride derivative thereof in the final mixture ranges from 0.05 wt % to 2 wt % of the final mixture.

Embodiment 12: The method of Embodiment 8, wherein the amount of the medium chain fatty acid (C6-C14) or the 1-monoglyceride derivative thereof in the final mixture ranges from about 1 wt % to about 10 wt % of the final mixture.

Embodiment 13: A cosmetic composition comprising: a preservative composition of Embodiment 1; and at least one selected from the group consisting of glycerin, a chelating agent, an emulsifier, a lipid, an ester, a particulate matter, a humectant, a gellant, an oil, a surfactant, caffeine, a saccharide, a hydrocarbon, a vitamin, and an antioxidant.

Embodiment 14: The cosmetic composition of Embodiment 13, wherein the amount of the preservative composition in the cosmetic composition ranges from 0.2 wt % to 5 wt % of the cosmetic composition.

Embodiment 15: The cosmetic composition of Embodiment 13, wherein the amount of the polylysine ranges from 0.01 wt % to 0.2 wt % of the cosmetic composition.

Embodiment 16: The cosmetic composition of Embodiment 13, wherein the amount of the medium chain fatty acid (C6-C14) or the 1-monoglyceride derivative thereof ranges from 0.05 wt % to 2 wt % of the cosmetic composition.

Embodiment 17: The cosmetic composition of Embodiment 13, wherein the amount of the medium chain fatty acid (C6-C14) or the 1-monoglyceride derivative thereof ranges from about 1 wt % to about 10 wt % of the cosmetic composition.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A preservative composition comprising:
a. polylysine; and
b. a medium chain fatty acid (C6-C14) or a 1-monoglyceride derivative thereof.

2. The preservative composition of claim 1, further comprising:
c. a glycol compound.

3. The preservative composition of claim 1, wherein at least one of the following applies:
(a) the polylysine comprises F-poly-L-lysine;
(b) the polylysine comprises 15 lysine residues to 50 lysine residues;
(c) the amount of the polylysine in the preservative composition ranges from about 1 wt % to about 10 wt % of the preservative composition.

4. The preservative composition of claim 1, wherein at least one of the following applies:
(a) the preservative composition comprises the 1-monoglyceride derivative of the medium chain fatty acid (C6-C14);
(b) the medium chain fatty acid (C6-C14) or the 1-monoglyceride derivative thereof is glyceryl caprylate;
(c) the amount of the medium chain fatty acid (C6-C14) or the 1-monoglyceride derivative thereof ranges from 5 wt % to 70 wt % of the preservative composition.

5. The preservative composition of claim 2, wherein at least one of the following applies:
(a) the glycol compound comprises at least one selected from the group consisting of ethylene glycol, propanediol, butanediol, pentanediol, hexanediol, and cyclohexanediol;
(b) the glycol compound comprises propanediol;
(c) the amount of the glycol compound ranges from about 5 wt % to about 70 wt % of the preservative composition.

6. The preservative composition of claim 1, wherein apart from an agent used to adjust the pH of the preservative composition, the preservative composition does not comprise a non-naturally derived product.

7. The preservative composition of claim 2, wherein apart from an agent used to adjust the pH of the preservative composition, the preservative composition does not comprise a non-naturally derived product.

8. A method of improving microbial resistance in a food, beverage, cosmetic product, or pharmaceutical product, the method comprising mixing the food, beverage, cosmetic product, or pharmaceutical product with a preservative composition of claim 1.

9. The method of claim 8, wherein the amount of the preservative composition mixed with the food, beverage, cosmetic product, or pharmaceutical product ranges from 0.2 wt % to 5 wt % of the final mixture.

10. The method of claim 8, wherein the amount of the polylysine in the final mixture ranges from 0.01 wt % to 0.2 wt % of the final mixture.

11. The method of claim 8, wherein the amount of the medium chain fatty acid (C6-C14) or the 1-monoglyceride derivative thereof in the final mixture ranges from 0.05 wt % to 2 wt % of the final mixture.

12. The method of claim 8, wherein the amount of the medium chain fatty acid (C6-C14) or the 1-monoglyceride derivative thereof in the final mixture ranges from about 1 wt % to about 10 wt % of the final mixture.

13. A cosmetic composition comprising:
a. a preservative composition of claim 1; and
b. at least one selected from the group consisting of glycerin, a chelating agent, an emulsifier, a lipid, an ester, a particulate matter, a humectant, a gellant, an oil, a surfactant, caffeine, a saccharide, a hydrocarbon, a vitamin, and an antioxidant.

14. The cosmetic composition of claim 13, wherein the amount of the preservative composition in the cosmetic composition ranges from 0.2 wt % to 5 wt % of the cosmetic composition.

15. The cosmetic composition of claim 13, wherein the amount of the polylysine ranges from 0.01 wt % to 0.2 wt % of the cosmetic composition.

16. The cosmetic composition of claim 13, wherein the amount of the medium chain fatty acid (C6-C14) or the 1-monoglyceride derivative thereof ranges from 0.05 wt % to 2 wt % of the cosmetic composition.

17. The cosmetic composition of claim 13, wherein the amount of the medium chain fatty acid (C6-C14) or the 1-monoglyceride derivative thereof ranges from about 1 wt % to about 10 wt % of the cosmetic composition.
